(19) United States
(12) Patent Application Publication
(10) Pub. No.: US 2014/0170441 A1
(43) Pub. Date: Jun. 19, 2014

(54) TiAgN COATING LAYER, TiAgN COATING METHOD AND TiAgN COATING APPARATUS

(71) Applicant: HYUNDAI MOTOR COMPANY, Seoul (KR)

(72) Inventors: Hyuk Kang, Suwon (KR); Woong Pyo Hong, Yongin (KR); In Woong Lyo, Suwon (KR); Kwang Hoon Choi, Anyang (KR)

(73) Assignee: HYUNDAI MOTOR COMPANY, Seoul (KR)

(21) Appl. No.: 13/796,506

(22) Filed: Mar. 12, 2013

(30) Foreign Application Priority Data
Dec. 13, 2012 (KR) 10-2012-0145789

(51) Int. Cl. B32B 15/01; C23C 4/10

(52) U.S. Cl. CPC B32B 15/01; C23C 4/10
USPC 428/660; 427/569; 118/620; 508/170

(57) ABSTRACT

Disclosed is a TiAgN coating layer, which is coated by plasma coating method using nitrogen gas, a Ti source and a Ag source, the coating layer comprising Ag in the coating layer at an amount of about 15 at % or more, a TiAgN coating method, and a TiAgN coating apparatus therefor.

### CROSS-REFERENCE TO RELATED APPLICATION

This application claims under 35 U.S.C. §119(a) the benefit of Korean Patent Application No. 10-2012-0145789 filed Dec. 13, 2012 the entire contents of which are incorporated herein by reference.

### BACKGROUND

(a) Technical Field

The present invention relates to a TiAgN coating layer, a TiAgN coating method and a TiAgN coating apparatus, wherein the TiAgN coating layer is provided with softness at its surface. In particular, according to the present invention, Ag, a soft metal, is overgrown on the high hardness TiAgN coating. As such, according to the present invention, when metal to metal contact causes a temperature rises, Ag moves to the surface of the coating to improve load carrying capacity and wear resistance and to maximize low friction characteristic at the same time.

(b) Background Art

Until recently, lead and copper alloys have been used for high load bearings such as engines. Due to environment regulation, mono-metal bearings (Al₁₁Si), bi-metal bearings (AlSn, AlSnSi, AlSnNiMn), tri-metal bearings (No tin: Al₄Si, Al₁₁Si, AlZnMg) and the like are now used. However, there is a problem of reducing low friction and durability of such materials. Thus, there it is a need for bearing materials or substitutes, for applications such as high power engines, which do not contain lead but still have improved low friction and durability.

For bearings manufactured by using PVD coatings, soft metal-based materials such as Al₂₀Sn and Al₄₀Sn are used. However, with such materials, there are problems in that wear resistance and load carrying capacity are reduced due to softness. On the other hand, when using materials having high hardness, friction is increased due to high hardness. Thus, such materials result in poor bearing performance.

Conventional “Forming method of electronic material layer and electronic device and apparatus adopting the method” of KR10-2011-0016347 A describes “a forming method of a thin layer based on sputtering for electronic and electric devices. Layers, which have good electric/material characteristics as well as protect a substrate, or a lower laminated layer or structure formed on the substrate from damage caused by plasma, can be obtained. As a subject material, conductive, semiconductive and resistance materials can be used, and TCO (Transparent Conductive Oxide) materials such as ITO (Indium Tin Oxide) can be used. Deposition method includes forming of a unit electronic material layer or a unit electrode layer by sputtering and surface treatment of a unit electronic material layer or a unit electrode layer by neutral beam obtained from nonreactive atoms”.

However, no method to date is capable of providing a TiAgN coating layer, and particularly, a coating layer that does not use lead and the like, but still provides sufficient low friction and durability for use as high load bearings.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the above-described problems associated with prior art. The present invention provides a TiAgN coating layer, a TiAgN coating method and a TiAgN coating apparatus, wherein the coating is provided with softness at its surface by overgrowing Ag, a soft metal, on the high hardness TiAgN coating material. In particular, during metal to metal contact, increases in temperature cause the Ag to move to the surface of the coated part to improve load carrying capacity and wear resistance and to further maximize low friction characteristics.

According to one aspect, the TiAgN coating layer according to the present invention is coated by a plasma coating method using nitrogen gas, a Ti source and an Ag source. In particular, the coating layer is provided such that Ag is present in the coating layer at an amount of about 15 at % or more, wherein at % is the atomic percent with respect to the total atoms within the coating layer.

According to various embodiments, in the coating layer, the Ag is overgrown on the top layer thereof. By referring to Ag as being “overgrown” it is meant that Ag grain is grown by being added another Ag grains continuously.

According to various embodiments, the TiAgN coating method of the present invention provides a TiAgN coating using a plasma coating method. In particular, the plasma coating method uses nitrogen gas, a Ti source and an Ag source. According to various embodiments, the amount of the Ag in the coating layer is controlled to about 15 at % or more by controlling the Ti source and/or the Ag source.

According to various embodiments, power of the Ti source is limited to provide a current of about 50 A (Ampere) or less.

According to various embodiments, power of the Ag source is controlled to provide a current of about 1.5˜2.5 A.

According to various embodiments, atmospheric temperature of the coating process is controlled to about 300˜400° C.

According to another aspect, the TiAgN coating apparatus of the present invention is a TiAgN coating apparatus configured for carrying out a plasma coating method, and comprises: a jig equipped with a base material; an inlet where nitrogen gas as an atmosphere gas is inserted; a Ti source and a Ag source; and a control unit, which controls the Ti source and/or the Ag source when coating. According to various embodiments, the control unit is configured so as to control the Ti source and/or Ag source such that the amount of Ag in the formed coating layer is about 15 at % or more.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a drawing showing the TiAgN coating apparatus according to one embodiment of the present invention;

FIGS. 2 and 3 are images of structures for comparing overgrowth of Ag on a TiAgN coating layer based on content of Ag; and

FIGS. 4 to 7 are images of structures demonstrating a non-uniform Ag concentration of a TiAgN coating layer according to embodiments of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the TiAgN coating layer, the TiAgN coating method and the TiAgN coating apparatus according to preferred embodiments of the present invention now will be described in detail with reference to the accompanying drawings.

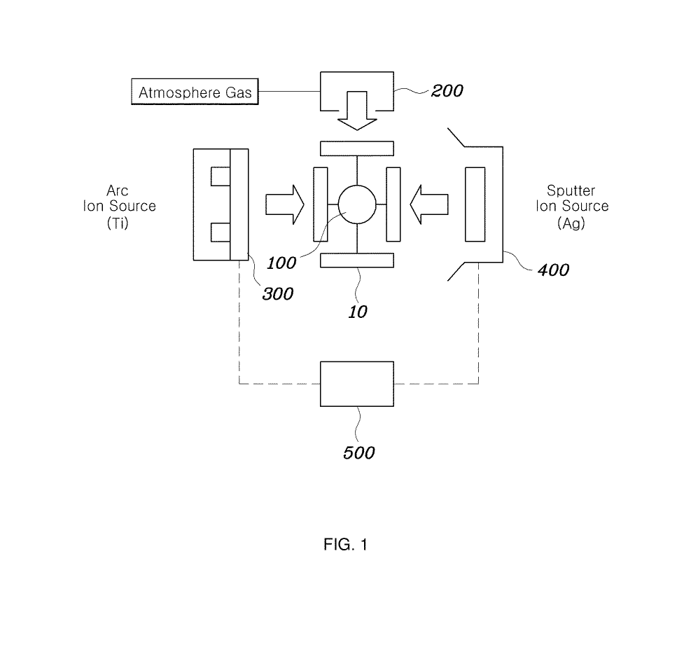

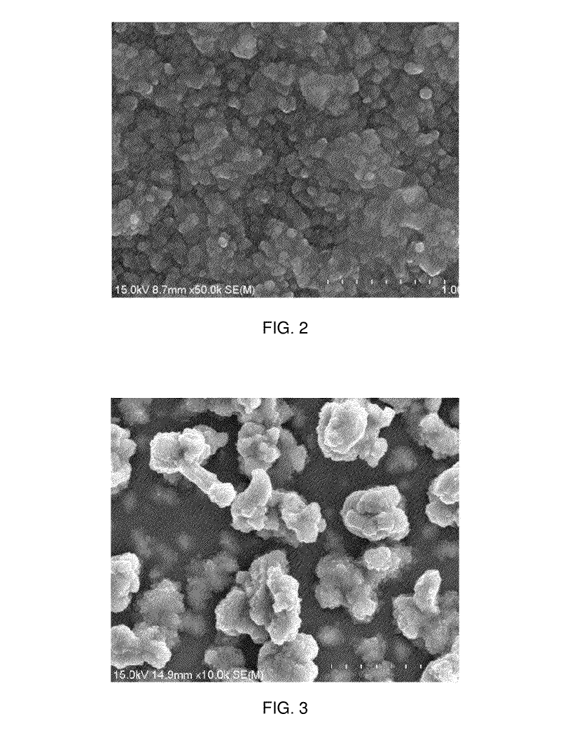

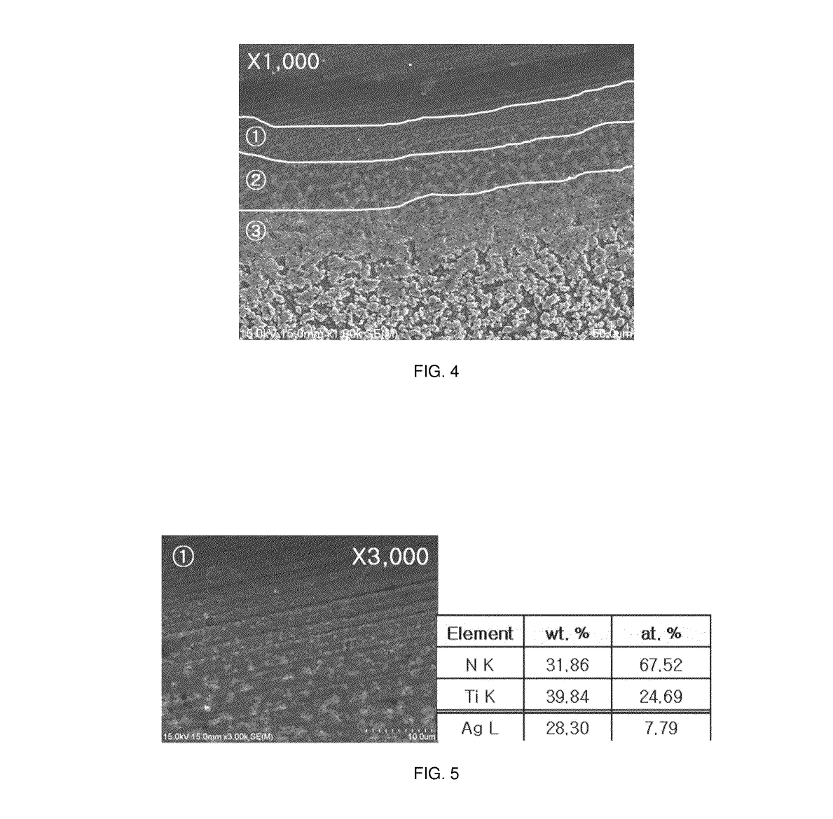

FIG. 1 is a drawing showing the TiAgN coating apparatus according to one embodiment of the present invention; FIGS. 2 and 3 are images of structures for comparing overgrowth of Ag on a TiAgN coating layer based on Ag content, wherein the content of Ag in FIG. 2 is not within the range provided by the present invention, and wherein the amount of Ag in FIG. 3 is in accordance with an embodiment of the present invention; and FIGS. 4 to 7 are images of structures demonstrating non-uniform Ag concentration of a TiAgN coating layer according to embodiments of the present invention.

The TiAgN coating layer of the present invention is one that provides both heat resistance of TiN and low friction of Ag. Such coating layers are preferably manufactured by a plasma coating method. Plasma coating methods are well-known methods and, thus, the general features with respect to the present method can be in accordance with those of conventional methods.

FIG. 1 is a drawing showing the TiAgN coating apparatus according to one embodiment of the present invention. The TiAgN coating apparatus is configured so as to carry out a plasma coating method, and comprises, as shown: a jig 100 equipped with a base material 10; an inlet 200 where nitrogen gas as an atmosphere gas is provided; a Ti source 300 and a Ag source 400; and a control unit 500, which controls the Ti source 300 and/or the Ag source 400. According to preferred embodiments, the control unit 500 is configured to control the Ti source 300 and/or the Ag source 400 when coating so as to control the amount of the Ag in the coating layer. Preferably, the amount of Ag in the coating layer is controlled to about 15 at % or more, wherein at % is the atomic percent with respect to the total atoms in the coating layer.

Namely, in the present invention, the Ti source 300 and/or the Ag source 400 is controlled to provide Ag at about 15 at % or more. By thus controlling the amount of Ag, a TiAgN coating is obtained in which Ag is overgrown. With such a structure, when temperature of the surface of a part thus coated rises by friction of the Ag particles formed on the surface, the Ag particles formed inside the coating layer move to the surface of the part. In other words, during use of a part coated with the present TiAgN coating, friction between the Ag particles on the surface and a metal causes an increase in temperature which causes Ag particles within the coating layer to move to the surface of the coating layer. As such, a low friction effect is maintained, and wear resistance and load carrying capacity can be maintained as they are because a TiN coating film having high hardness remains on the surface of the part even if the Ag is exhausted.

According to further embodiments, a TiAgN coating method using the coating apparatus is a plasma coating method. In particular, the coating method uses nitrogen gas, a Ti source and an Ag source. According to a preferred method, the amount of Ag formed in the coating layer is controlled to about 15 at % or more by controlling. This can be accomplished by controlling one or both of the Ti source and the Ag source.

Preferably, power of the Ti source is limited to provide a current of about 50 A or less, power of the Ag source is controlled to provide a current of about 1.5˜2.5 A, and atmosphere temperature of the coating process is controlled to about 300˜400° C.

Specific process conditions are as follows.

TABLE 1
Process Parameter and Deposition Condition

| Arc Current | Sputter Current | Voltage | Process Temperature |
|---|---|---|---|
| ~50 A or less | 1.5~2.5 A | 100~250 V | 300~450° C. |

Coating is conducted while maintaining the Ti source, the Ag source and the atmosphere temperature within the above conditions so as to obtain a TiAgN coating, wherein the Ag is overgrown.

Specifically, when conducting a hybrid PVD process (wherein hybrid generally refers to the use of an arc ion source of Ti and a sputter ion source of Ag) as illustrated in FIG. 1, the Ti Arc power is minimized to provide a current of about 50 A or less and the Ag sputter power is set to provide a current of about 1.5˜2.5 A so as to control the amount of the Ag in the coating material to about 15 at % or more. This process further forms a Ag out-diffusion path in the coating material. In particular, a pathway through which Ag can diffuse from within an interior portion of the material to the surface of the material is provided.

Further, by maintaining the coating process temperature at about 300˜400° C., Ag diffusion through the Ag diffusion path in the coating material and Ag growth occur. As such, the TiAgN coating material, wherein the Ag is overgrown on the surface of the coating material, is manufactured. Through this coating process, by applying the overgrown TiAgN coating to a part, better metal bearing performance is provided. In particular, performance characteristics including excellent wear resistance, load carrying capacity and low friction characteristics are improved and are superior to the characteristics of lead/copper alloy metal bearing materials.

Shown in FIGS. 2 and 3 are images of structures for comparing overgrowth of the Ag on the TiAgN coating layer. In particular, FIG. 2 shows a coating layer formed with N 69.88 at %, Ti 16.05 at % and Ag 14.06 at %, and FIG. 3 shows a coating layer formed with N 70.00 at %, Ti 13.27 at %, Ag 16.73 at %. As demonstrated, when the amount of the Ag is below 15 at %, Ag is not overgrown (FIG. 2), and when the amount of Ag is increased to 15 at % or more, the Ag is overgrown (FIG. 3).

Accordingly, the Ag out-diffusion path is formed in the coating material by minimizing the Ti Arc power to provide a current of about 50 A or less, setting the Ag sputter power to provide a current of about 1.5˜2.5 A and manufacturing the coating material to maintain the amount of the Ag in the coating material at about 15 at % or more.

Further, by maintaining the coating process temperature within about 300˜400° C., Ag diffusion through the Ag diffusion path in the coating material and Ag growth occur. As a result, the TiAgN coating material of the present invention, wherein the Ag is overgrown on the surface of the coating material, is manufactured.

FIGS. 4 to 7 are images of structures that demonstrate non-uniform Ag concentration of the TiAgN coating layer. In particular, and FIG. 4 is a detailed image of the entire structure of the TiAgN coating layer (wherein the upper portion of the image is towards the inside of the coating layer, and the lower portion of the image is towards the surface of the coating layer).

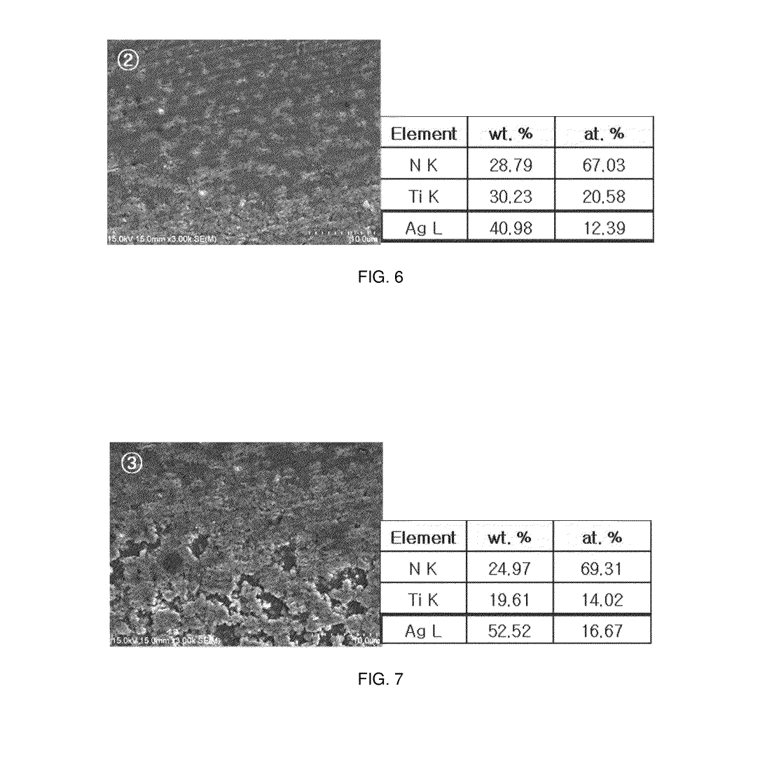

FIGS. 5, 6 and 7 are detailed images of partial structures of the coating shown in FIG. 4, along with the wt % and at % of the components. In particular, FIG. 5 shows a detailed image of the top portion of FIG. 4 in region 1, FIG. 6 shows a detailed image of the top portion of FIG. 4 in region 2, and FIG. 7 shows a detailed image of the top portion of FIG. 4 in region 3, along with the wt % and at % of the components in each of these regions 1-4. As shown, it is confirmed that the amount of the Ag, i.e., low friction metal, is increased toward the surface of the coating layer (lower portion of the image of FIG. 4, region 3). This means that the amount of the Ag is increased toward the surface by diffusion and the Ag is overgrown by controlling the amount of the Ag in the coating material at 15 at % or more and forming a Ag out-diffusion path in the coating material. This is accomplished by the present invention by minimizing the Ti Arc power to provide a current of about 50 A or less and setting the Ag sputter power to provide a current of about 1.5˜2.5 A when conducting the hybrid PVD process.

Through this, the TiAgN coating, wherein the Ag is overgrown, can be obtained. According to the present invention, when a temperature of the surface part (the surface of the coated part, e.g. bearing) rises during use by friction of the Ag particles formed on the surface, the Ag particles formed inside move to the surface part. As a result, a low friction effect is maintained, and wear resistance and load carrying capacity can be maintained during use because the TiN in the coating film, which is a material having high hardness, remains on the surface even though the Ag is exhausted during use.

According to aspects of the present invention, the TiAgN coating layer manufactured by the above process is coated by plasma coating method using nitrogen gas, a Ti source and an Ag source. In particular, the TiAgN coating layer comprises the Ag in the coating layer at the amount of about 15 at % or more. Further, in the coating layer, the Ag is overgrown on the top layer.

According to the present invention, the TiAgN coating layer, the coating method and the coating apparatus provide excellent results with respect to the friction coefficient at room temperature (25° C.) and the friction coefficient at high temperature (200° C.). In particular, the present invention provides a TiAgN coating layer that demonstrates a friction coefficient at room temperature (25° C.) of about 0.41 or more and a friction coefficient at high temperature (200° C.) of about 0.32 or more.

Further, the present invention is superior to prior bearing and coating materials, such as lead alloy metal bearings, in that when temperature rises by friction through metal to metal contact, the lead moves from the inside of the part to the surface part so as to have wear resistance. However, as the lead is exhausted, the soft metal is worn out. This results in a rapid decrease in seizure resistance and load carrying capacity by metal-metal contact. Accordingly, seizure between metals is generated, and the metal bearing effect is gone.

On the other hand, in the case of the TiAgN coating of the present invention, when temperature of the surface part rises by friction of the Ag particles overgrown on the surface, the Ag particles formed inside of the coating move to the surface, thereby maintaining low friction effect. Further, wear resistance and load carrying capacity can be maintained as they are during use because the TiN in the coating film, which is a material having high hardness, remains on the surface even though the Ag is exhausted.

Further, according to the present invention, the coating is provided such that the metal-metal contact circumstances change to coating layer-metal contact circumstances. As a result, excellent wear resistance and load carrying capacity are secured.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. A TiAgN coating layer, which is coated by a plasma coating method using nitrogen gas, a Ti source and a Ag source, the coating layer comprising Ag in the coating layer at an amount of about 15 at % or more, wherein at % is the atomic percent based on total atoms in the coating layer.

2. The TiAgN coating layer according to claim 1, wherein the Ag is overgrown in a top layer of the TiAgN coating layer.

3. A TiAgN plasma coating method for forming a TiAgN coating layer comprising: using nitrogen gas, a Ti source and a Ag source, wherein an amount of Ag in the coating layer is controlled to about 15 at % or more by controlling the Ti source and/or the Ag source, wherein at % is the atomic percent based on total atoms in the coating layer.

4. The TiAgN coating method according to claim 3, wherein power of the Ti source is limited to provide a current of about 50 A or less.

5. The TiAgN coating method according to claim 3, wherein power of the Ag source is controlled to provide a current of about 1.5˜2.5 A.

6. The TiAgN coating method according to claim 3, wherein atmosphere temperature of the coating process is maintained at about 300˜400° C.

7. A TiAgN coating apparatus using a plasma coating method comprising:
a jig equipped with a base material;
an inlet through which nitrogen gas as an atmosphere gas is inserted;
a Ti source and a Ag source; and
a control unit, the control unit configured and arranged to control the Ti source and/or the Ag source during coating so as to control an amount of Ag in the coating layer at about 15 at % or more, wherein at % is the atomic percent based on total atoms in the coating layer.
